(19) United States
(12) Patent Application Publication
(10) Pub. No.: US 2007/0291913 A1
(43) Pub. Date: Dec. 20, 2007

(54) Systems and arrangements for determining communication parameters in a network environment

(76) Inventor: Solomon Trainin, Haifa (IL)

Correspondence Address: SCHUBERT, OSTERRIEDER & NICKELSON, PLLC;c/o Intellevate, P.O. BOX 52050, MINNEAPOLIS, MN, 55402, US

(21) Appl. No.: 11/454,704

(22) Filed: Jun. 16, 2006

(51) Int. Cl. H04M 11/00

(52) U.S. Cl. 379/93.08

(57) ABSTRACT

Systems and methods for utilizing new communication standards in wireless local area networks are provided that also support legacy wireless stations. The method can include a station that transmits a signal having a communication format selected from a plurality of communication formats. A bit rate calculator of the station can determine a reference bit rate of the transmission based the communication format of the transmission. A bit rate search module of the station can locate and select a bit rate from a legacy basic bit rate set based on the reference bit rate and the selected bit rate can be utilized when receiving a reply transmission.

### FIELD

The present disclosure relates generally to wireless communications. More particularly, embodiments of the present disclosure are in the field of determining communication parameters to facilitate communications in a network environment.

### BRIEF DESCRIPTION OF THE DRAWINGS

FIG. 1 depicts an embodiment of a wireless network;

FIG. 2 is a timing diagram illustrating a possible signaling format for a network;

FIG. 3 depicts an apparatus for facilitating network communications;

FIG. 4 is a flow diagram that provides methods that can be utilized to facilitate network communications; and

FIG. 5 is another flow diagram that provides methods that can be utilized to facilitate network communications.

### DETAILED DESCRIPTION OF EMBODIMENTS

The following is a detailed description of embodiments of the disclosure depicted in the accompanying drawings. The embodiments are introduced in such detail as to clearly communicate the disclosure. However, the embodiment(s) presented herein are merely illustrative, and are not intended to limit the anticipated variations of such embodiments; on the contrary, the disclosure is to cover all modifications, equivalents, and alternatives falling within the spirit and scope of the appended claims. The detailed descriptions below are designed to make such embodiments obvious to those of ordinary skill in the art.

The consumer demand for mobile communications continues to increase at a robust pace. Wireless communications have become ubiquitous in nearly all heavily populated parts of the world. Accordingly, more and more wireless local area networks (WLANS) continue to be implemented throughout the world. WLANs are very popular in offices, hotels and in institutional setting such as in schools and colleges. One reason for such popularity, is that WLANs are relatively easy to install and maintain. For example, installation of a single access point can “simultaneously” support many users, allowing these users access to the Internet. Such a large consumer demand for Internet access and mobile services has many WLANs overloaded. Overloading a WLAN generally, significantly degrades the performance of the WLAN. For example, a WLAN may inadvertently drop users, may provide poor service to users and may be very slow to upload and download data for users when it is overloaded.

Correspondingly, there has been a lot of activity by committees and standards organizations to develop standards for the next generation of WLAN equipment that can meet the growing consumer demand. The Institute of Electrical and Electronic Engineers (IEEE) is one group that is active in creating such WLAN standards. One proposed standard that will allow WLANs to accommodate more users and operate more efficiently is proposed IEEE standard 802.11n sometimes referred to as 802.11TGn, for the “Technical Group” that is working on this proposed addendum. All versions of IEEE std. 802.11n will be referred to herein as “802.11n.” 802.11n defines many new communication formats that can be utilized by devices to communicate. However, to ensure that older devices or legacy systems can still communicate with newer devices that support the 802.11n specification, at least some of the transmissions by the newer devices should be intelligible by the legacy devices.

When an 802.11n compliant station such as a personal or laptop computer, a personal digital assistant, a radio telephone etc. attempts to join a WLAN, the station will exchange “set-up” information with an 802.11n compliant access point, wherein the access point can provide a connection to the Internet for the station. Such set up information can include communication parameters such as bit rates, delays, supported communication formats and a legacy basic bit rate set. The supported communication formats and parameters can define different communication streams, modulations, coding rates, guard intervals, bit rates etc. that a station can request, and then utilize when communicating with the access point. The legacy basic bit rate set includes bit rates that all the stations associated with the access point should use when transmitting specific control frames such that legacy stations can become part of the WLAN. The usage of bit rates from the legacy basic bit rate set allows legacy stations to receive and process information contained in the control frames such that all stations associated with this access point can achieve a fair amount of service from the access point. Both the 802.11n compliant access point and the 802.11n compliant stations can store the communication parameters including a legacy basic bit rate set, and legacy stations can store just the legacy basic bit rate set. Both types of stations can access this stored data and notify the access point during an initial part of a communication session of the communication parameters that the station will utilize during subsequent communications.

Legacy systems, including systems that comply with existing IEEE std. 802.11, released in 1999, std. 802.11a ratified in 1999, std. 802.11b ratified in 1999 and std. 802.11 g ratified in 2003, each have a defined basic bit rate set. For example, std. 802.11 includes data rates of 1 and 2 mega bits per second (Mbs), std. 802.11b includes data rates of 1, 2, 5.5, and 11 Mbs, std. 802.11a includes data rates of 6, 9, 12, 18, 24, 36, 48 and 54 Mbs and std 802.11 g includes all of the bit rates in versions a and b. The bit rates mentioned above are referred to herein collectively as legacy bit rates. Each WLAN can define a legacy basic rate set (that contains legacy bit rates) and utilize the bit rates defined in its legacy basic rate set to exchange control frames in a communication sequence. Thus, a legacy basic bit rate set as defined by each WLAN or access point will typically be a plurality bit rates that correspond to at least some of the abovementioned legacy bit rates.

802.11 n specifies many “new” bit rates that are significantly different than legacy bit rates. Thus, transmissions with these newly defined bit rates, and communication formats generally will not be intelligible by the legacy devices. If a legacy device cannot receive and process transmissions from an access point, then the legacy station cannot become synchronized with the WLAN and cannot connect to, and communicate with the WLAN or the access point. Accordingly, one issue with the new high throughput systems defined by 802.11n, is that at least some of the control information can be transmitted utilizing bit rates from the legacy basic rate set, such that legacy stations can process the control transmissions and achieve synchronization with the WLAN.

In one embodiment, an initial transmission can be made from a source to a destination, wherein the transmission can have a communication format selectable from a plurality of communication formats. Such formats can include formats defined by 802.11 n that provide high throughput data rates. A bit rate of the communication format can be determined based on the modulation and coding index parameters of communication format.

In accordance with the present disclosure, 802.11n compliant stations can utilize the communication format defined by 802.11n, however, the last control frames in a communication session can have a bit rate selected from the legacy basic bit rate set of the WLAN. However, this disclosure also contemplates and does not exclude possible future or yet to be developed communication parameters, communication formats and bit rates.

Such a selection feature can select a highest bit rate from a legacy basic bit rate set that is comparable to the bit rate that has been successfully utilized in prior communications. This assumption can be based on an 802.11n compliant access point and station achieving a bit rate that is optimal and having the station and the access point choose a similar but lower bit rate from the legacy basic bit rate than the bit rate that has been determine to be an optimal bit rate.

Since most of the bit rates defined by 802.11n do not directly correlate to bit rates defined in legacy basic bit rate sets, the 802.11n compatible devices can select a bit rate from the legacy basic bit rate set that is a next lower bit rate than the bit rate of the last data or payload bearing transmission. For example, if the legacy basic bit rate set has values of 4, 6, 8, 24 and 48 Mbs and the payload transmissions utilizes a bit rate of 36, a bit rate of 24 can be selected for the control or reply frames, because a bit rate of 24 Mbs is the next lower bit rate in the legacy basic bit rate set than 36 Mbs.

Using a bit rate from the legacy basic bit rate set in at least one control frame transmission allows a legacy station to calculate time periods for frames and time periods of fields such as duration fields. Determining these time periods allow a legacy station to become synchronized with, and become part of an 802.11n compliant WLAN. In one embodiment, the control transmission is an acknowledgement (ACK) transmission sent by an access point to a station to provide status information regarding the communication session.

In accordance with another embodiment, an apparatus such as a wireless station includes a transmitter adapted to make a transmission. The apparatus also includes a reference bit rate look up module to determine a reference bit rate for an 802.11n compliant transmission. The apparatus can further include a search module to determine when the reference bit rate is defined in a legacy basic bit rate set, and to search for a lower bit rate in the legacy basic bit rate set when the reference bit rate is not a bit rate defined in the legacy basic bit rate set. The apparatus can also include a receiver to receive a reply transmission to the transmission, the reply transmission having a bit rate selected from the legacy basic bit rate set based on the reference bit rate. In a particular embodiment, the apparatus includes a duration field calculation module to calculate a time period for a duration field utilizing the selected bit rate. In another embodiment the apparatus includes a timer module to determine a time delay between an end of the duration field and a time for another transmission, such that the station can become time synchronized with the access point.

In another embodiment, an access point is disclosed that can service multiple stations including legacy stations and 802.11n compliant stations. The access point can have a receiver to receive a transmission from at least one station and a bit rate module to determine a bit rate of the received transmission and to determine a bit rate useable in a reply-control transmission. The bit rate for the reply transmission can be selected from the legacy basic bit rate set of the WLAN and the exact bit rate selected can be in response to the determined bit rate of the received transmission. For example, a reply bit rate can be selected from the legacy basic bit set that is equal to, or lower than, the bit rate of the previous data transmission. Alternately described, the access point can select a bit rate for reply transmissions from a legacy basic bit rate set that is “not higher than” the rate as determined from the 802.11n complaint transmission of the preceding transmission. The access point can also include a transmitter to transmit a reply transmission having the selected bit rate.

In yet another embodiment, a machine-accessible medium is provided that contains instructions to facilitate communications between devices in a wireless network. The method can include receiving a transmission, determining a modulation and a coding rate of the transmission and determining a reference bit rate based on the modulation and the coding rate of the transmission. When the reference bit rate matches a legacy bit rate, the reference bit rate can be utilized in corresponding control transmission and when the reference bit rate does not match a bit rate in the legacy basic bit rate set, a next lower rate in the legacy basic bit rate set can be chosen and utilized in the reply transmission.

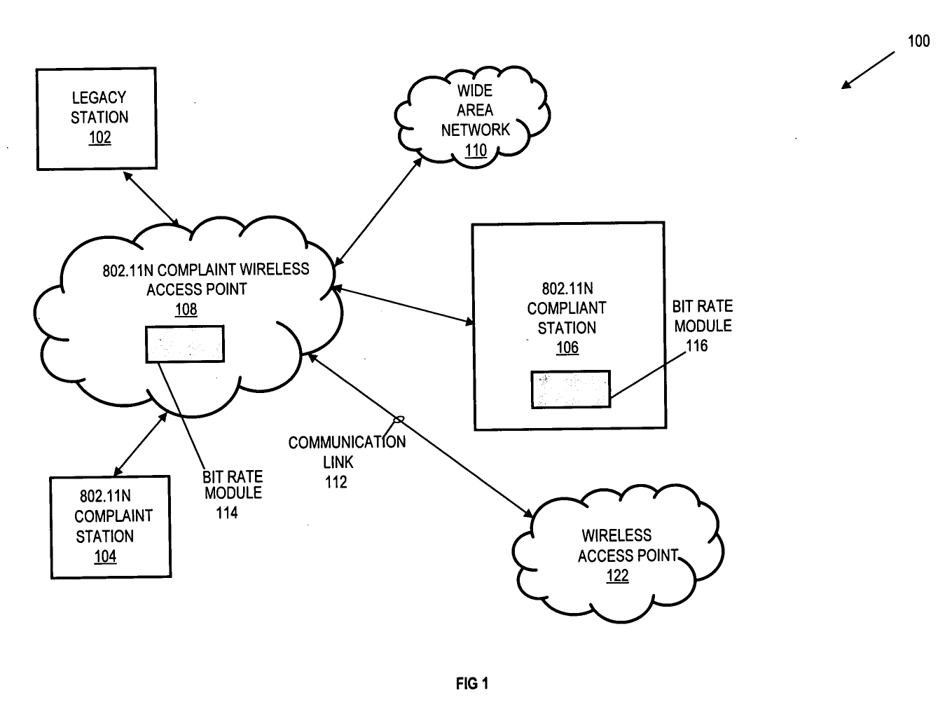

Referring to FIG. 1, a wireless local area network (WLAN) 100 embodiment is described, however the teachings herein could be utilized for near field communications (NFC)s, wireless municipal area network (WMAN), a mesh network, cellular type communications, WiMax, radio access network for radio termination equipment (RAN-LTE), fourth generation wireless (4G), and other types of wireless and wired communication networks. In the embodiment illustrated, wireless access points and stations are described however, this should not be considered as a limiting factor, as other types of devices and other types of network configurations could also utilize and benefit from the teachings herein.

The WLAN system 100 can have an 802.11n compliant access point 108 and multiple stations such as legacy station 102, 802.11n compliant station 104, and 802.11n compliant station 106 (stations 102-106) that can connect to a wide area network 110 via wireless access point 108. The wide area network 110 could be a telecommunications system such as the Internet. A second wireless access point 122 could also be in the area and wireless access point 108 could communicate with wireless access point 122 to form a “mesh” type network via communication link 112. Stations 102-106 can take many forms such as a personal digital assistant, a laptop computer, a radio-telephone, and the like.

In accordance with the present disclosure, wireless access point 108 can include an access point bit rate module 114 and station 106 can include a station bit rate module 116. Station bit rate module 116 and access point bit rate module 114 can exchange set up information including communication parameters such as bit rates, delays, supported communication formats and a legacy basic bit rate set. Further, the station bit rate module 116, and access point bit rate module 114 can negotiate communication parameters and determine an optimum bit rate for communication in accordance with the 802.11n specification and they can also both select or agree upon a legacy bit rate for particular control transmissions. When exchanging at least some control information the access point 108 and the station 106 can synchronize and communicate at least some control information utilizing a bit rate that is part of a legacy basic bit rate set, such that legacy stations 102 and 104 can synchronize and join the network as will be discussed in more detail below.

In the illustrated configuration, wireless access point 108 provides multiple input multiple output (MIMO) capabilities in accordance with the 802.11n specification and can provide the modulation and coding formats illustrated in Table 1 below. Wireless access point 108 can support space division multiple access (SDMA) communications in which multiple spatial streams are utilized to allocate power among spatial channels. Sharing of the wireless media is implemented by relying on synchronized time slots that are allocated collectively by the access point 108 and the stations 102-106. Time allocation between stations 102-106 and the access point 106 is an important part of the synchronization of WLAN communications and to the sharing of time allocations between the access point 108 and stations 102-106.

Generally a station, such as legacy station 102 or 802.11n compliant station 104, may connect to the LAN, by initiating a scanning or beaconing process to find a WLAN access point, such as access point, 108 that can connect the station 102 or 104 to a network. Station 104 and access point 108 can perform an authentication and authorization process where the access point 108 can provide a legacy basic bit rate set and in some embodiments MCS indexes to the station 104. Thereafter, the station 104 can select a bit rate from the legacy basic bit rate set or a communication format from the MCS indexes for subsequent transmissions. Thus, during this set up process, the access point 108 can notify a new station 104 of the set of bit rates and communication formats that the access point can process (legacy bit rates and MCS indexes) and can provide other communication parameters that define generally, how signals can be transmitted within the WLAN. Typical legacy stations can interpret transmissions having bit rates in the legacy basic bit rate set and legacy stations can synchronize and communicate with the access point of the WLAN utilizing at least some of the bit rates defined in the legacy basic bit rate set. In a particular embodiment, the legacy basic bit rate set can be a set of bit rates defined by IEEE std. 802.11g.

More particularly, since transmissions within WLAN are time synchronized, it is important that legacy stations, such as legacy station 102 can receive and process information associated with at least some control frames and become synchronized with devices in the WLAN. With the advent of spatial streams and beam steering in MIMO systems that can steer radio waves, it is possible that only the station in communication with the access point receives a transmission from the access point. More specifically, wireless access point 108 can make transmissions that are not be received by all stations (i.e. 102-108) either joined with, or attempting to join the WLAN. Thus, in accordance with the present disclosure an 802.11 n compliant access point 108 can transmit at least some control signals with a uniform power distribution or a uniform radiation pattern such that all stations in range of the access point (i.e. stations 102-106) are likely to receive the transmission. Alternatively described, an access point can transmit at least certain control information in a radiation pattern that is similar to radiation patterns found in legacy systems.

As defined in 802.11n, devices that are compliant with 802.11n can perform an adaptive process between, for example, a station and an access point to find a communication format with an optimum bit rate. In such a system, after a station is coupled to an access point, the station can request to transmit utilizing communication formats having higher bit rates, selecting such formats from MCS indexes provided in 802.11n. Early in such transmissions, a station can send information to the access point indicating which MCS index will be utilized in subsequent transmissions. In 802.111n compliant systems, when transmissions having certain MCS indexes create higher than acceptable bit error rates, a stations can request and attempt different MCS indexes in subsequent transmissions in an attempt to optimize communication performance.

Such a process can attempt to optimize the performance of each communication link between the access point and each station. Generally, a station can increase the rate at which it communicates by changing the modulation and the coding rates. The optimization process can attempt to optimize a quality of service (QoS) parameter. Such an optimization process offers advantages in building the support for “bandwidth-hungry” applications and time-critical services like VoIP, wireless multimedia, and mesh networks.

Referring below to Table 1, proposed modulation coding schemes (MCS)s for 802.11n compliant systems are illustrated. These communication formats can be utilized to exchange some control information and data between network devices such as between stations and access points in accordance with 802.11n. Many formats are being proposed, and Table 1 below illustrates some of these proposed communication formats. In accordance with the present disclosure, reference bit rates have been assigned to MCS indexes.

TABLE 1
Modulation and Coding formats.
/BIT RATES FOR MOD/CODE/GI/CAR FREQ/

| MCS | # of s/ | | Coding | GI = 800 ns | GI = 800 ns | GI = 400 ns | GI = 400 ns | Ref. Bit |
|---|---|---|---|---|---|---|---|---|
| index | streams | Modulation | Rate | R = 20 MHz | R = 40 MHz | R = 20 MHz | R = 40 MHz | Rate |
| 0 | 1 | BPSK | ½ | 6.5 | 13.5 | 7.2 | 15.0 | 6 |
| 1 | 1 | QPSK | ½ | 13.0 | 27.0 | 14.4 | 30.0 | 12 |
| 2 | 1 | QPSK | ¾ | 19.5 | 40.5 | 21.7 | 45.0 | 18 |
| 3 | 1 | 16-QAM | ½ | 26.0 | 54.0 | 28.9 | 60.0 | 24 |
| 4 | 1 | 16-QAM | ¾ | 39.0 | 81.0 | 43.3 | 90.0 | 36 |
| 5 | 1 | 64-QAM | ⅔ | 52 | 108.0 | 57.8 | 120.0 | 48 |
| 6 | 1 | 64-QAM | ¾ | 58.5 | 121.5 | 65.0 | 135.0 | 54 |
| 7 | 1 | 64-QAM | ⅚ | 65.0 | 135.0 | 72.2 | 150.0 | 54 |
| 8 | 2 | BPSK | ½ | 13.0 | 27.0 | 14.444 | 30.0 | 6 |
| 9 | 2 | QPSK | ½ | 26.0 | 54.0 | 28.889 | 60.0 | 12 |
| 10 | 2 | QPSK | ¾ | 39.0 | 81.0 | 43.333 | 90.0 | 18 |
| 11 | 2 | 16-QAM | ½ | 52.0 | 108.0 | 57.778 | 120.0 | 24 |
| 12 | 2 | 16-QAM | ¾ | 78.0 | 162.0 | 86.667 | 180.0 | 36 |
| 13 | 2 | 64-QAM | ⅔ | 104 | 216.0 | 115.556 | 240.0 | 48 |
| 14 | 2 | 64-QAM | ¾ | 117.0 | 243.0 | 130.0 | 270.0 | 54 |
| 15 | 2 | 64-QAM | ⅚ | 130.0 | 270.0 | 144.444 | 300.0 | 54 |

Table 1 illustrates proposed modulation and coding schemes (MCS)s and provides a MCS index, where each MCS index 1,2,3 . . . etc. defines different types of communication formats or different methodologies for communication. Generally, different transmission rates (i.e. bits per second) can result from different MCS indexes, i.e. different spatial streams, different frequencies (i.e. 20 and 40 MHz channels) and different Guard Intervals (GI). For example, a communication format with an MCS index of 5 has a single spatial stream with a 64 quadrature amplitude modulation, a coding rate of two thirds, a bit rate of 52, 108, 57.8, and 120 as determined by the different guard intervals (GI)s and modulation frequencies utilized by the transmitter. In different modulation coding sequences, signal impairments due to multiple paths can be virtually eliminated through the use of a cyclic prefix guard interval (during which no modulation is performed by the receiver). Such communication formats allow higher transmission rates such that more users can be serviced, time-critical applications can perform adequately, more services can be provided, and faster uploads and faster downloads can be achieved.

Table 1 also illustrates, how the same amount of information can be transferred (i.e. same bit rate can be achieved) utilizing many different communication formats. For example, in Table 1 MCS 5 can achieve a bit rate of 52 Mb/s using one spatial stream, with 64 QAM with a coding rate or 2/3. A rate of 52 Mb/s can also be achieved under two spatial streams, with 16-QAM and a coding rate ½ (MCS 11). As can be appreciated, the communication formats and bit rates defined by the MCS indexes are substantially different than those found in legacy systems. However as stated above, it is important to remain “downward” compatible such that legacy stations can connect to, and communicate with an 802.11 n compliant WLAN.

In accordance with the present disclosure, access point 108 and station 106 can communicate utilizing the communication formats described in Table 1 above. However, when exchanging at least some control information, access point 108 and station 104 can determine a reference bit rate (column nine) and determine if the reference bit rate is part of a legacy basic bit rate set of the WLAN. If the reference bit rate matches a bit rate in the legacy basic bit rate set then the access point can utilize the reference bit rate for at least a portion of the control transmissions to allow legacy devices such as legacy station 102 to become synchronized with or stay synchronized with 802.11n compliant access point 108.

Table 2 below generally illustrates how the reference bit rate in column nine of Table 1 can be determined based on a modulation and coding rate. For example, Table 2 can be utilized by a reference bit rate look-up module to determine a reference bit rate that will often, but not always match a legacy bit rate and if no match can be located, then the reference bit rate look up module can utilize the reference bit rate to search for a bit rate in a legacy basic bit rate set. Based on the communication format and the entries in Table 2 below, the bit rate look up module can determine a reference bit rate that, when the reference bit rate matches a bit rate in the legacy basic bit rate set can be utilized in control type transmissions such that network operation can stay compliant with legacy systems.

TABLE 2
Bit Rate conversion table

| | | BIT RATE |
|---|---|---|
| MODULATION | CODING RATE | Mbs |
| BPSK | ½ | 6 |
| BPSK | ¾ | 9 |
| QPSK | ½ | 12 |
| QPSK | ¾ | 18 |
| 16-QAM | ½ | 24 |
| 16-QAM | ¾ | 36 |
| 64-QAM | ⅔ | 48 |
| 64-QAM | ¾ | 54 |
| 64-QAM | ⅚ | 54 |

Table 2 above provides one way for a bit rate look up module to determine a reference bit rate that can be assigned to 802.11n compliant transmissions. The bit rate look up module can determine a bit rate based on a modulation of the transmission (in column 1 of Table 1) and a coding rate (in column 2 of Table 1) of the transmission. For example, referring briefly to Table 1, a transmission having a MCS index of 12 has a modulation of 16-QAM and a coding rate of ¾. Referring to line 6 of Table 2, it can be determined that the reference bit rate for a transmission having a MCS index of 12, is 36. As stated above, after a reference bit rate of the transmission is determined, this reference bit rate can be compared to bit rates in the legacy basic bit rate set in a selection process for a reply bit rate for a reply transmission. In one embodiment the selected reply bit rate could be a bit rate selected from the legacy basic bit rate set that is less than but closest to the bit rate of a previous transmission, but generally not a bit rate that is higher than the reference bit rate.

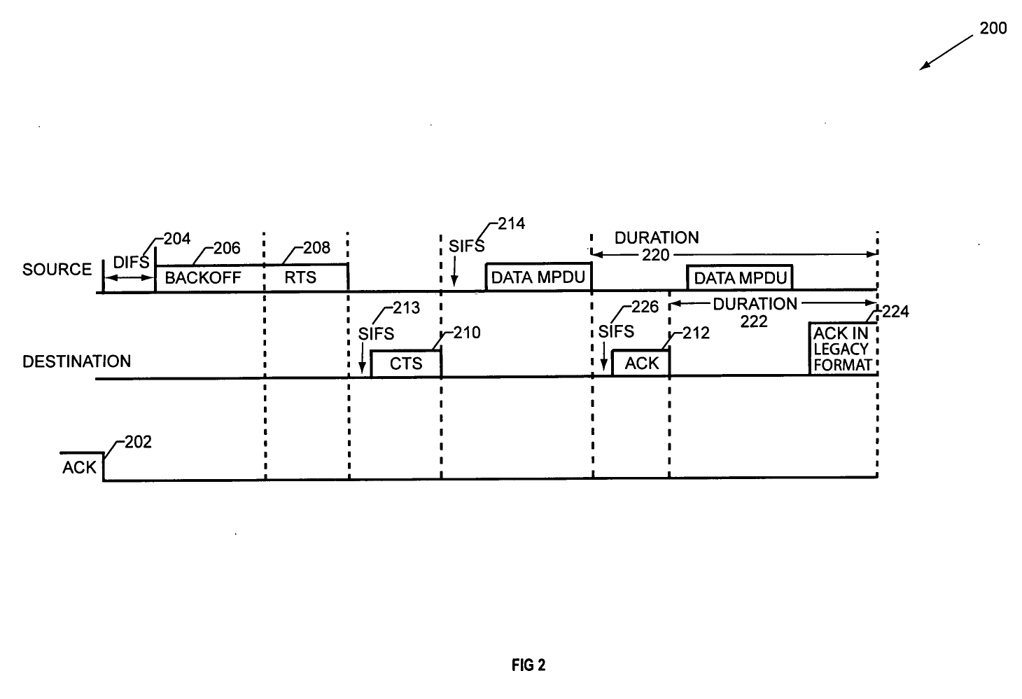

Referring to FIG. 2, an example of a timing diagram for portion of a communication session 200 that can occur between a source such as a station, and a destination such as an access point in accordance with 802.11n is provided. The communication session 200 diagram provides a particular exchange of information between the access point and at least one station in a WLAN. Communication session 200 between the station and the access point can start after a “termination” acknowledgement (ACK) frame 202 is transmitted by the access point. Such a termination ACK will typically contain a duration field of value=0 to indicate that the ACK frame is the last frame in a communication session. In the illustration, termination ACK frame 202 is the last packet in a series of packets communicated between the access point and the station.

After such a termination ACK frame 202, a distributed control function inter-frame spacing (DIFS) time delay 204 occurs, and then a back-off time interval 206 occurs. During the back off time interval 206, every station in a WLAN can produce an arbitrary delay and after the arbitrary delay, stations that have instructions to communicate can transmit a ready to send (RTS) signal 208. The station that is the first to have its timer module “time out” can send a first RTS signal 208 to the access point. After the short inter-frame spacing (SIFS) delay 213, the access point or a destination can transmit a reply (a control transmission) such as a clear to send (CTS) 210 signal. When a CTS 210 transmission occurs, the station can determine that it has an exclusive connection with the access point for a specified time. Generally, RTS, CTS, and ACK transmissions are referred to herein as control transmissions because such transmissions do not carry data as a payload, but instead convey some form of control information for the operation of the WLAN and are referred to herein as control transmissions.

After a SIFS 214 time interval, the station can transmit a media access protocol data unit (MPDU) possibly having DATA, (i.e. a payload) to exchange data between the station and the access point. In response, the access point can transmit the ACK frame 212 to acknowledge that the previous DATA MPDU transmission was successfully received. Assuming that the ACK 212 transmission is a last transmission in a communication session it is important that all listening stations know when the last ACK transmission 212 in a communication session is occurring, such that the stations can start their random timers in an attempt to initiate communications with the access point.

In accordance with one embodiment of the present disclosure, 802.11n compliant or newer equipment can transmit RTS, CTS, MPDU and DATA frames utilizing bit rates that are not defined in a legacy basic bit rate set. However, at least the terminating ACK 212 in a communication session 200 can be transmitted utilizing a bit rate that is recognized by legacy devices (i.e. a bit rate that is defined in the legacy basic bit rate set). As described above, a transmission bit rate can be determined utilizing the MCS index in 802.11n, and a legacy bit rate can be selected for ACK transmissions such as termination ACK transmission 212.

It can be appreciated that the time duration of the duration fields 220 and 222 can change based on the bit rate of the ACK transmission. The number of bits in an ACK transmission is a fixed/known quantity, thus, utilizing the bit rate, the duration of the ACK transmission 212 can be determined. Since the duration of the SIFS delay is known, the transmitting and replying stations can calculate the duration time periods 220 and 222. For example, the ACK frame 212 may contain two hundred bits and utilizing the selected bit rate from the legacy basic bit rate set, the transmitting station can determine a time period for the duration field 220 of the currently transmitted DATA MPDU frame. Thus, a station attempting to join the WLAN can determine the time period of the duration field 222 in the replied ACK frame 212 based on the selected bit rate. Therefore the duration field 222 can be calculated by subtracting the time of the duration field 220 of the DATA MPDU, by the transmission time of the ACK frame 212 and SIFS 216. Determining the time of the duration field 220 will allow legacy stations to compete for time slots with other stations at end of the transmission sequence (end of duration fields 220 and 222).

Referring to FIG; 3, an apparatus 300 is illustrated that can communicate at numerous bit rates and can utilize spatial streams and beam steering in accordance with a MIMO system, yet be compatible with legacy systems and devices. The apparatus 300 can include a bit rate calculator 302, a transmitter/receiver 304, a reference bit rate look up module 306, communication format selection module 308, search module 310, a duration filed calculator 312, a timer module 314, and an antenna array 316. Communication format selection module 308 and reference bit rate look-up module 306 can also include direct random access memory (DRAM). The DRAM can store tables and make other information readily available to these modules.

The apparatus 300 could function as an access point or a station. During operation, the transmitter 304 can transmit data to other devices via communication link 318. In order to allow legacy stations to connect to a network, an access point and a station that communicate utilizing newly defined communication formats in accordance with 802.11n must perform at least some communications at a bit rate and in a format that is intelligible by legacy stations.

In operation, the communication format selection module 308 can continually select communication formats in an attempt to optimize the bit rate, error rate, quality of service etc. of the communications between apparatus 300 and another 802.11n compliant device. Thus, communication format selection module 308 can communicate such a format request to the transmitter receiver 304 and the transmitter receiver 304 can utilized the requested formats to communicate over communication link 318 via antenna array 316.

To allow legacy stations to connect with the access point, the 802.11n compliant devices should, at some time, abandon the selected communication format and determine a bit rate from the legacy basic bit rate set for conducting at least some of the control type communications. Thus, in one embodiment, the bit rate calculator 302 can determine what communication format has been selected by the communication format selection module 308 and a reference bit rate of the communication format can be determined based on the format.

The reference bit rate look-up module 306 may determine a reference bit rate of the transmission between 802.11n compliant devices and the search module 310 can determine if the reference bit rate is a bit rate defined in the legacy basic bit rate set of the network. If the reference bit rate of the transmission is defined in the legacy basic bit rate set, then the 802.11n compliant devices can utilize the reference bit rate. If the reference bit rate cannot be located in the legacy basic bit rate set, the search module 310 of the 802.11n compliant device can select a bit rate from the legacy basic bit rate set that is lower than the reference bit rate of the previous transmission.

Since the bit rate of the previous transmissions between the 802.11n compliant devices will likely not be a bit rate defined in the legacy basic bit rate set, the search module 310 can search for a legacy bit rate, and select a bit rate from the legacy basic bit rate set that is close to, but not greater than the actual bit rate an in one embodiment of the reference bit rate. The selected bit rate can be utilized in at least some of the control transmissions or transmission that are reply transmissions to data transmissions. The reference bit rate look up module 306 can determine a reference bit rate of the transmission based on a bit rate provided by the bit rate calculator 302 and utilize an equation or a look up table in accordance with the same or a similar process described above with respect to Table 2 to determines such a reference rate. In one configuration, the transmitter/receiver 304 can set up to receive the reply-control transmission with the selected bit rate, wherein the reply-control transmission can utilize the selected bit rate as described above.

A time period for a duration field can be calculated by the duration field calculator 312 using the selected bit rate and other known time delays. Timer module 314 can be utilized to determine a time delay between an end of the duration field and a time for another transmission, such as a RTS transmission. Using a legacy bit rate allows legacy stations to receive and process the control information sent by an access point and to connect with the access point at an appropriate time.

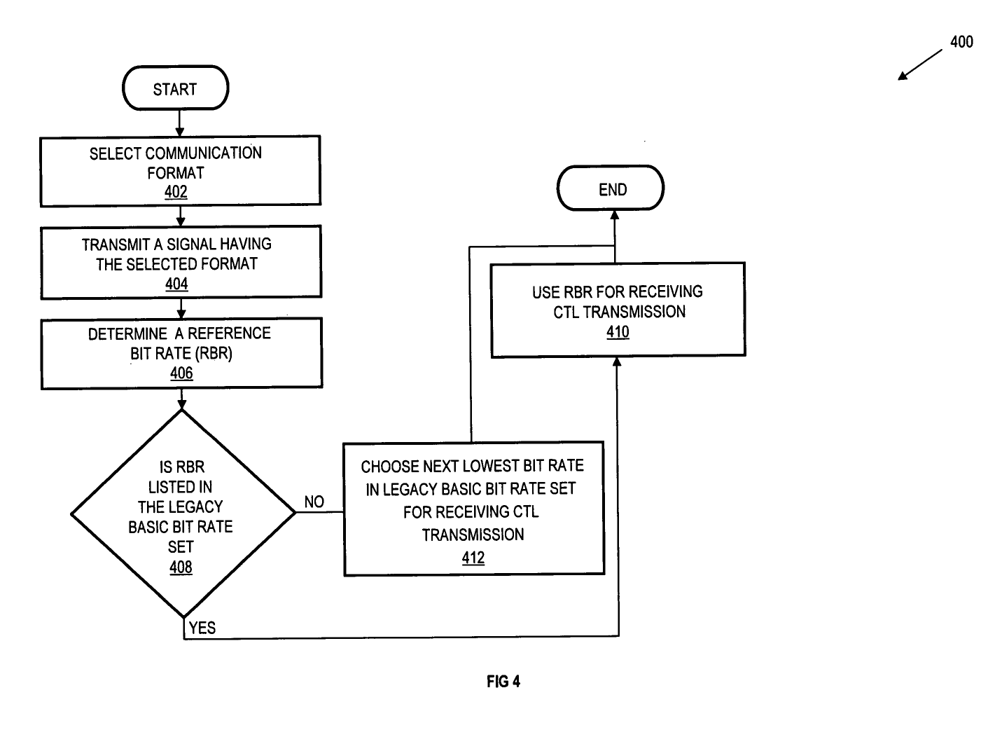

Referring now to FIG. 4, a method 400 for allowing legacy stations to synchronize with an 802.11n compliant WALN is disclosed. When an 802.11n compliant access point and an 802.11n compliant station communicate, the station can continually modify the communication formats in search of an optimum format, wherein such formats are unintelligible to legacy deices. Thus, to allow a legacy station to connect with the access point, the 802.11n compliant access point and station must communicate at least some control information at a legacy bit rate such that the legacy station can synchronize with the access point.

As illustrated by block 402, a communication format can be selected by a communications format selection module. As stated above, and in accordance with 802.11n, many new communication formats can be selected to form a communication link between the access point and different stations and such communication formats can continually change in search of an optimum format. A signal can be transmitted by a station that has the selected format as illustrated by block 404. A reference bit rate calculator for the transmission can be determined by a reference bit rate calculator based on the actual bit rate of a transmission as illustrated by block 406.

As illustrated by decision block 408, it can be determined if the reference bit rate of the transmission is a bit rate that is defined in the legacy basic bit rate set of the WLAN. If the reference bit rate is defined in the legacy bit rate set, then a subsequent reply-control transmission can utilize the reference bit rate. If the reference bit rate in not listed in the legacy basic bit rate set, the reply bit rate can be selected from the legacy basic bit rate set as a next lower bit rate than the reference bit rate. Alternately described, if the reference bit rate of the transmissions between the 802.11n compliant devices is not a bit rate defined in the legacy basic bit rate set, the selected bit rate can be a bit rate in the legacy basic bit rate that is not higher than the reference legacy bit rate as illustrated by block 410.

In one example, a WLAN can have a legacy basic rate set of: 6, 12, 24, and 36 Mbs. After authorization and authentication a station can transmit a frame to the access point utilizing one of the communication formats provided in Table 1. The station can select a communication format such as one spatial stream, a modulation of 64-QAM and coding rate 2/3 (MCS index 5). In this case, the data frame will be transmitted at bit rate of 52 Mbps. The station can then calculate the duration field of this frame taking into accounts the length of the ACK frame that will be sent by the access point in response to the transmitted frame. The reference bit rate determination module can use the modulation and coding rate as inputs to Table 2 above and in this particular case the reference bit rate will be 48 Mbps. However 48 Mbs is not a rate defined in the legacy basic bit rate set so the actual bit rate of the ACK transmission can be determined by both the access point and the station to be 36 Mbps.

In another example, the station or the access point may select a communication format having two spatial streams, under the modulation of 16-QAM, a coding rate=1/2 and achieve the same bit rate (i.e. 52 Mbs) in the above example (MCS index 11 from Table 1). Using the modulation and the coding rate in Table 2 reveals that the reference bit rate is 24 Mbps. Since, one of the values in the legacy basic bit rate set above is 24 Mbs, 24 mbs can be utilized by the transmitter and the receiver to exchange the control frame, and this can allow legacy stations to interpret the control transmissions.

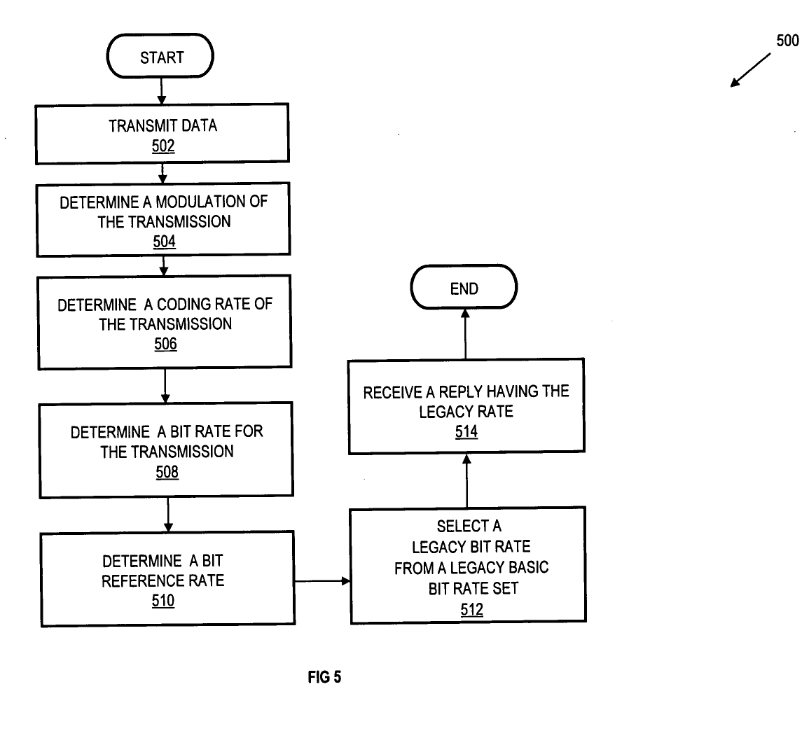

Referring to FIG. 5, another method for accommodating legacy systems in a WLAN with new communication formats is provided. As illustrated by block 502, a device can transmit data in accordance with a selected communication format that can have a specific modulation and a specific coding rate. The modulation and coding rate can be a communication format that is defined by an MCS index. A legacy bit rate can be determined from the modulation and coding rate.

A bit rate calculator can determine a modulation of the transmission as illustrated by block 504, and the bit rate calculator can also determine a coding rate of the transmission as illustrated by block 506. Using the modulation and the coding rate, the bit rate calculator can determine a bit rate of the transmission as illustrated by block 508. From the transmission bit rate, a reference bit rate can be determined as illustrated by block 510.

To define a legacy compliant rate for the control transmission that will allow legacy station to receive such information and connect to the access point, a bit rate look up module can select a legacy bit rate from a legacy basic bit rate set based on the reference bit rate as illustrated by block 512. Once the reference bit rate for the initial transmission is established then a bit rate look up module can compare the reference rate to legacy basic bit rates and if no corresponding bit rate or match occurs between the reference bit rate and rates defined by the legacy basic bit rate set, then a lower bit rate, such as a next lowest bit rate from the legacy basic bit rate set can be chosen as a bit rate for the reply-control transmission.

The device transmitting in accordance with the MCS indexes can receive a reply transmission having the determined bit rate as illustrated by block 514, and the process can end thereafter. A legacy station can utilize the legacy compliant transmission bit rate to calculate a duration value to ensure synchronization with the access point.

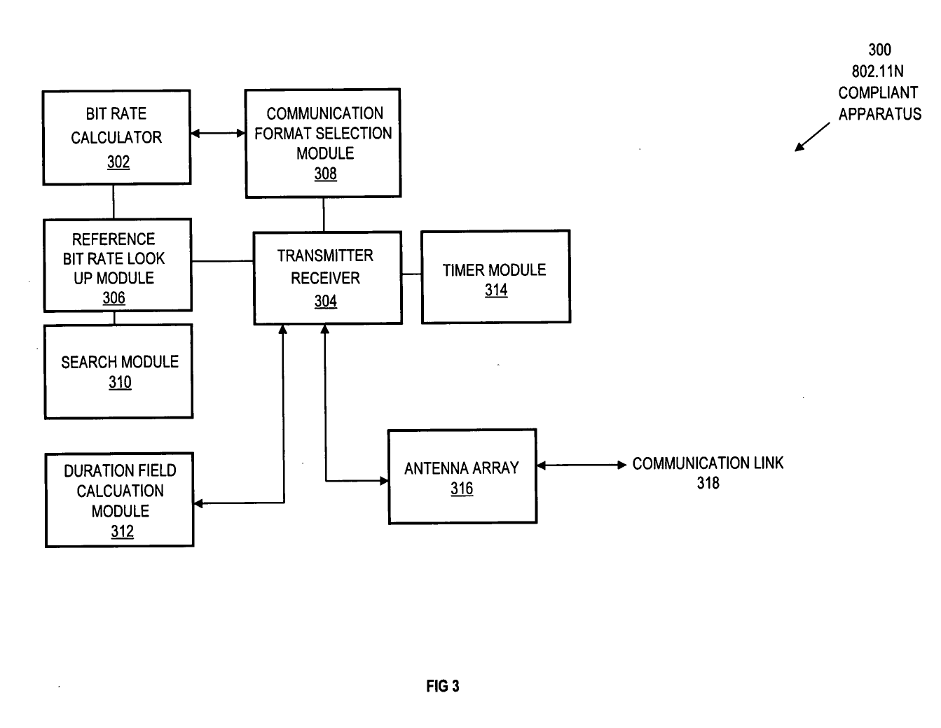

Another embodiment of the disclosure is implemented as a program product for implementing a legacy compliant WLAN with the systems and methods described with reference to FIGS. 1-5. The program(s) of the program product defines functions of the embodiments (including the methods described herein) and can be contained on a variety of data and/or signal-bearing media. Illustrative data and/or signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such data and/or signal-bearing media, when carrying computer-readable instructions that direct the functions of the present invention, represent embodiments of the present disclosure.

In general, the routines executed to implement the embodiments of the disclosure, may be part of an operating system or a specific application, component, program, module, object, or sequence of instructions. The computer program of the present invention typically is comprised of a multitude of instructions that will be translated by a computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the disclosure should not be limited to use solely in any specific application identified and/or implied by such nomenclature.

The present disclosure and some of its features have been described in detail for some embodiments. It should be understood that various changes, substitutions and alterations can be made herein without departing from the spirit and scope of the disclosure as defined by the appended claims. An embodiment of the disclosure may achieve multiple objectives, but not every embodiment falling within the scope of the attached claims will achieve every objective. Moreover, the scope of the present application is not intended to be limited to the particular embodiments of the process, machine, manufacture, composition of matter, means, methods and steps described in the specification. One of ordinary skill in the art will readily appreciate from the disclosure of the present invention that processes, machines, manufacture, compositions of matter, means, methods, or steps, presently existing or later to be developed are equivalent to, and fall within the scope of, what is claimed. Accordingly, the appended claims are intended to include within their scope such processes, machines, manufacture, compositions of matter, means, methods, or steps.

What is claimed is:

1. A method comprising:
transmitting a signal having a communication format that is selectable from a plurality of communication formats;
determining a reference bit rate of the signal based on the communication format; and
selecting a bit rate from a legacy basic bit rate set based on the reference bit rate.

2. The method of claim 1, wherein selecting further comprises selecting a legacy bit rate from the legacy basic bit rate set that matches the reference bit rate and selecting a next lower bit rate from the legacy basic bit rate set in response to a failure to locate a legacy bit rate that matches the reference bit rate in the legacy basic bit rate set and receiving a reply transmission utilizing the selected bit rate.

3. The method of claim 1, further comprising calculating a time period of a duration field based on the selected bit rate of the reply transmission.

4. The method of claim 3, wherein calculating comprises dividing the selected bit rate of the reply transmission by a number of bits in the reply transmission to determine a reply transmission time period and adding an inter-frame spacing time period to the reply transmission time period.

5. The method of claim 1, further comprising transmitting a reply with a radiation pattern in accordance with a legacy radiation pattern.

6. The method of claim 1, wherein determining comprises obtaining the first bit rate from a look up table based on parameters of the communication format.

7. The method of claim 6, wherein the communication parameters comprise a modulation and a coding rate.

8. The method of claim 1, wherein a lower bit rate comprises a next lower bit rate in the legacy bit rate set than the reference bit rate.

9. An apparatus comprising;
a transmitter to make a transmission;
a bit rate module to calculate a first bit rate of the transmission;
a bit rate look-up module to determine a reply bit rate of a reply transmission based on the first bit rate, wherein the reply bit rate is selectable from a legacy basic bit rate set; and
a receiver to receive a reply transmission, the reply transmission having a bit rate that is selected as a next lower bit rate in the legacy basic bit rate set than the first bit rate.

10. The apparatus of claim 9, further comprising a duration field calculation module to calculate a time period for a duration field, the duration field comprising the reply transmission, the calculation based on a bit rate of the reply transmission.

11. The apparatus of claim 9, further comprising a timing module to determine a time delay between an end of the duration field and a time to initiate another transmission.

12. The apparatus of claim 9, wherein the apparatus comprises at least part of a station.

13. A communication apparatus for servicing multiple stations comprising:
a receiver to receive a transmission from at least one station;
a bit rate module to determine a reference bit rate of the received transmission and to determine a reply bit rate, the reply bit rate being the reference rate according to the reference rate matching a bit rate in a legacy basic bit rate set and the reply bit rate being a next lower bit rate in the legacy basic bit rate set according to the absence of a bit rate in the legacy basic bit rate set that relates to the reference bit rate; and
a transmitter to transmit a reply transmission, the reply transmission having the reply bit rate.

14. The system of claim 13, wherein at least one of the stations is an 802.11n complaint station.

15. The system of claim 13, wherein the reply bit rate is a bit rate that is compliant with an 802.11g specification.

16. The system of claim 13, wherein the reply transmission is an acknowledgement transmission.

17. The system of claim 13, wherein the system further comprises at least one look-up table to select the reply bit rate from the legacy basic bit rate set.

18. The system of claim 13, wherein the bit rate module negotiates bit rates for payload based transmissions, wherein the payload based transmission are in accordance with modulation and coding indexes of a 802.11n specification.

19. A machine-accessible medium containing instructions to facilitate communications, said machine to perform operations comprising:
sending a transmission;
determining a modulation of the transmission;
determining a coding rate of the transmission;
determining a transmit bit rate of the transmission based on the modulation and the coding rate;
determining a reply bit rate from a legacy bit rate set in response to the transmit bit rate; and
receiving a reply transmission with the reply bit rate.

20. The machine-accessible medium of claim 19, further comprising creating a random time interval in response to the reply transmission and transmitting control information after the random time interval.

21. The machine-accessible medium of claim 19, wherein determining the reply bit rate comprises utilizing a look up table.

22. The machine-accessible medium of claim 19, wherein the reply bit rate is substantially similar to the transmit bit rate.

23. The machine-accessible medium of claim 19, wherein the reply bit rate is a next lower bit rate in the legacy bit rate set than the transmission bit rate.
